(19) United States
(12) Patent Application Publication
(10) Pub. No.: US 2016/0110664 A1
(43) Pub. Date: Apr. 21, 2016

(54) DETERMINING LEVELS OF COMPLIANCE BASED ON PRINCIPLES AND POINTS OF FOCUS

(71) Applicants: Michelle Marks, Blue Bell, PA (US); Yasemin Agatan, Blue Bell, PA (US)

(72) Inventors: Michelle Marks, Blue Bell, PA (US); Yasemin Agatan, Blue Bell, PA (US)

(73) Assignee: Unisys Corporation, Blue Bell, PA (US)

(21) Appl. No.: 14/519,638

(22) Filed: Oct. 21, 2014

(51) Int. Cl. G06Q 10/06

(52) U.S. Cl. CPC G06Q 10/0639

(57) ABSTRACT

Software may be used to organize controls in an organization from multiple groups within the organization to determine a level of compliance with specified principles. A method for determining compliance may include receiving a list of controls; receiving a plurality of point of focus identifications, wherein each point of focus of the plurality of point of focus identifications correspond to a control of the list of controls; and determining a compliance score for a plurality of principles based, at least in part, on the received points of focus.

### FIELD OF THE DISCLOSURE

The instant disclosure relates to determining compliance with a set of rules. More specifically, this disclosure relates to calculating a compliance score.

### BACKGROUND

Companies and other organizations often have internal controls to help the organization meet established principles. One example of internal controls is established in a framework set forth by the Committee of Sponsoring Organizations of the Tradeway Commission (COSO). Two versions of the COSO framework exist—a 1992 version and a 2013 version (collectively, the “COSO Frameworks”). The COSO Frameworks establish internal control based on a number of key principles focused around the control environment, risk assessment, control activities, information and communication, and monitoring. In addition to certain internal controls, some internal controls are mandated by outside organizations and/or laws. For example, the Sarbanes-Oxley Act is one law that establishes certain principles of accounting that certain organizations must follow.

For management to conclude that its system of internal controls is effective, all principles must be present in internal monitoring protocols and all relevant principles must be present and functioning. In particular, a principle may be present if a given component or principle exists within the internal control design and within an implementation of an entity's system of internal control. Also, a principle may be functioning if the component or principle continues to exist in the operation and conduct of the internal control system. Further requirements may exist. For example, effective internal controls may also require that all components operate together in an integrated manner.

The organizations use internal controls to comply with the principles. However, the controls are often implemented by different groups within the organization and without any central management. Further, controls may be routinely established and removed from the groups, such as when personnel responsible for the controls change. When the controls change, there is no central management to ensure that all of the principles are complied with.

### SUMMARY

Software may be used to organize controls in an organization from multiple groups within the organization to determine a level of compliance with specified principles. The specified principles may include, for example, those specified by the COSO Frameworks. The COSO Frameworks may include “Internal Control-Integrated Framework Executive Summary,” “Internal Control-Integrated Framework and Appendices,” “Internal Control-Integrated Framework Illustrative Tools for Assessing Effectiveness of a System of Internal Control,” and “Internal Control over External Financial Reporting: A Compendium of Approaches and Examples,” which are incorporated by reference herein. According to one embodiment, a method may include receiving a list of controls; receiving a plurality of point of focus identifications, wherein each point of focus of the plurality of point of focus identifications correspond to a control of the list of controls; and determining a compliance score for a plurality of principles based, at least in part, on the received points of focus.

According to another embodiment, a computer program product may include a non-transitory computer readable medium comprising code to perform the steps of receiving a list of controls; receiving a plurality of point of focus identifications, wherein each point of focus of the plurality of point of focus identifications correspond to a control of the list of controls; and determining a compliance score for a plurality of principles based, at least in part, on the received points of focus.

According to yet another embodiment, an apparatus may include a memory; and a processor coupled to the memory. The processor may be configured to perform the steps of receiving a list of controls; receiving a plurality of point of focus identifications, wherein each point of focus of the plurality of point of focus identifications correspond to a control of the list of controls; and determining a compliance score for a plurality of principles based, at least in part, on the received points of focus.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an illustration of data input received for calculating a compliance score according to one embodiment of the disclosure.

FIG. 2 is an illustration of a calculation of a compliance score according to one embodiment of the disclosure.

FIG. 3 is a flow chart illustrating a method of determining compliance according to one embodiment of the disclosure.

FIG. 4 is a block diagram illustrating a computer network according to one embodiment of the disclosure.

FIG. 5 is a block diagram illustrating a computer system according to one embodiment of the disclosure.

### DETAILED DESCRIPTION

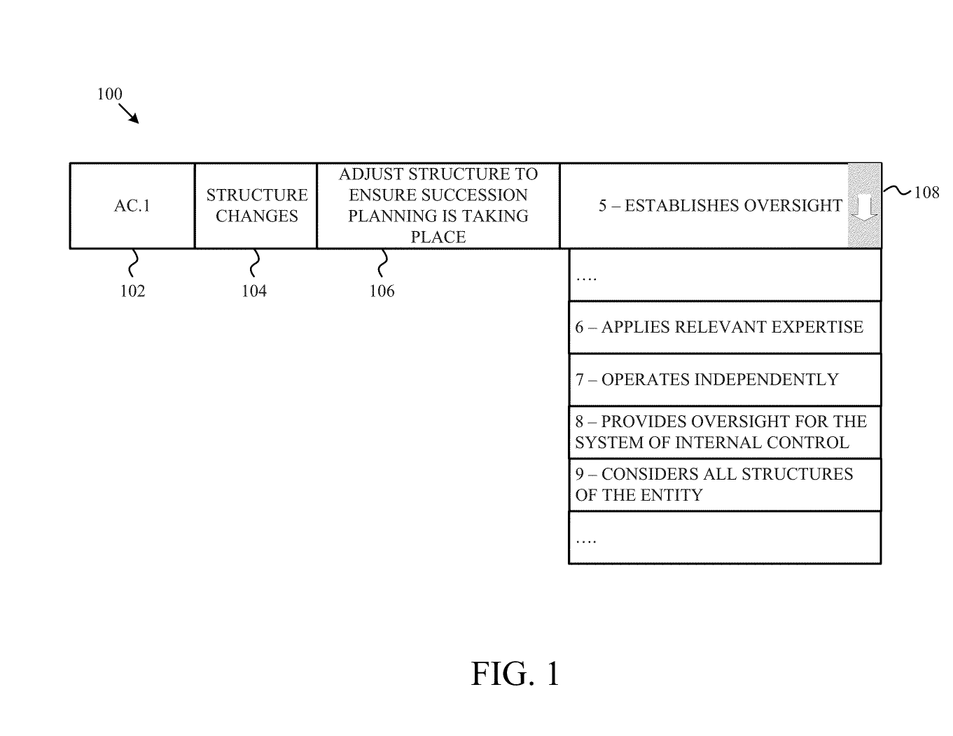

FIG. 1 is an illustration of data input received for calculating a compliance score according to one embodiment of the disclosure. Data input 100 may be received through, for example, a window in an application built for the Windows, Apple, or Linux operating systems. The data input 100 may alternatively be received through an application built for an Android-, iOS-, or WINDOWS Mobile-based mobile device. The data input 100 may alternatively be received through a form on a web page served by a server on the Internet. The data input 100 may alternatively be received through a spreadsheet or other format of data file, such as a comma-delimited text file.

The data input 100 may include a box 102 for a control number, a box 104 for control name, a box 106 for control description, and a box 108 for point-of-focus identified for the control. Multiple rows of data may be provided corresponding to multiple controls established with a company. The box 108 may be a listbox-style control that provides a list of options, containing the available points-of-focus for identification, to allow selection of one or more points-of-focus for the control listed on the row. Although a sample format for data input is shown in FIG. 1, the display form for receiving data input 100 may vary.

In one embodiment, the list of points-of-focus may include one or more of: sets the tone at the top; establishes standards of conduct; evaluates adherence to standards of conduct; addresses deviations in a timely manner; establishes oversight responsibilities; applies relevant expertise; operates independently; provides Oversight for the System of Internal Control; considers all structures of the entity; establishes reporting lines; defines, assigns, and limits authorities and responsibilities; establishes policies and practices; evaluates competence and addresses shortcomings; attracts, develops, and retains individuals; plans and prepares for succession; enforces accountability through structures, authorities and responsibilities; establishes performance measures, incentives, and rewards; evaluates performance measures, incentives, and rewards for ongoing relevance; considers excessive pressures; evaluates performance and rewards or disciplines individuals; complies with applicable accounting standards; considers materiality; reflects entity activities (External Financial Reporting Objectives); complies with externally established standards and frameworks; considers the required level of precision; reflects entity activities (External Non-Financial Reporting Objectives); includes entity, subsidiary, division, operating unit, and functional levels; analyzes internal and external factors; involves appropriate levels of management; estimates significance of risks identified; determines how to respond to risks; considers various types of fraud; assesses incentives and pressures; assesses opportunities; assesses attitudes and rationalizations; assesses changes in the external environment; assesses changes in the business model; assesses changes in leadership; integrates with risk assessment; considers entity-specific factors; determines relevant business processes; evaluates a mix of control activity types; considers at what level activities are applied; addresses segregation of duties; determines dependency between the use of technology in business processes and technology general controls; establishes relevant technology infrastructure control activities; establishes relevant security management process control activities; establishes relevant technology acquisition, development, and maintenance process control activities; establishes policies and procedures to support deployment of management's directives; establishes responsibility and accountability for executing policies and procedures; performs in a timely manner; takes corrective action; performs using competent personnel; reassesses policies and procedures; identifies information requirements; captures internal and external sources of data; processes relevant data into information; maintains quality throughout processing; considers costs and benefits; communicates internal control information; communicates with the board of directors; provides separate communication lines; selects relevant method of communication; communicates to external parties; enables inbound communications; communicates with the board of directors; provides separate communication lines; selects relevant method of communication; considers a mix of ongoing and separate evaluations; considers rate of change; establishes baseline understanding; uses knowledgeable personnel; integrates with business processes; adjusts scope and frequency; objectively evaluates; assesses results; communicates deficiencies; and/or monitors corrective actions. In one embodiment, the points-of-focus may be selected to assist in the determination of a compliance of controls within the company in accordance with Sarbanes-Oxley.

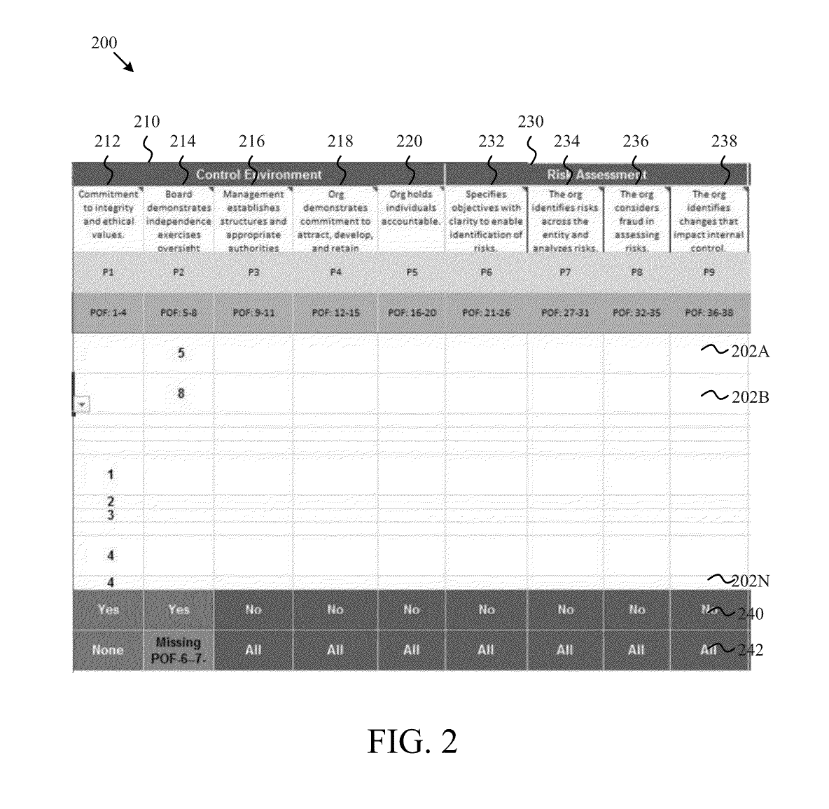

FIG. 2 is an illustration of a calculation of a compliance score according to one embodiment of the disclosure. A matrix 200 may be used to determine a compliance based on the data input 100. The matrix 200 may include columns 212-220 and 232-238 corresponding to principles associated with the points-of-focus listed in listbox 108 of FIG. 1. That is, each principle in the columns 212-220 and 232-238 may be associated with one or more points-of-focus. For example, as shown in FIG. 2, the principle “Commitment to integrity and ethical values” may be associated with points-of-focus 1-4 listed in the listbox 108.

Compliance for each principle may be determined by determining whether the points-of-focus of the principle have been addressed by controls in the company, received as part of the data input 100. The principles corresponding to columns 212-220 and 232-238 may be categorized into components 210 and 230. A compliance score may be calculated to determine a level of compliance within each principle. In one embodiment, the compliance score may be a yes/no value to indicate whether compliance for a principle is met, such as shown in row 240. When the compliance score indicates a “no” value, a row 242 may list any points-of-focus not addressed by the controls received in data input 100. In another embodiment, a compliance score may be a numerical value, such as percentage of points-of-focus addressed for a particular principle.

Principles for the columns 212-220 and 232-238 may include: the organization demonstrates a commitment to integrity and ethical values; the board of directors demonstrates independence from management and exercises oversight of the development and performance of internal control; management establishes, with board oversight, structures, reporting lines, and appropriate authorities and responsibilities in the pursuit of objectives; the organization demonstrates a commitment to attract, develop, and retain competent individuals in alignment with objectives; the organization holds individuals accountable for their internal control responsibilities in the pursuit of objectives; the organization specifies objectives with sufficient clarity to enable the identification and assessment of risks relating to objectives; the organization holds individuals accountable for their internal control responsibilities in the pursuit of objectives; the organization identifies risks to the achievement of its objectives across the entity and analyzes risks as a basis for determining how the risks should be managed; the organization considers the potential for fraud in assessing risks to the achievement of objectives; the organization identifies and assesses changes that could significantly impact the system of internal control; the organization selects and develops control activities that contribute to the mitigation of risks to the achievement of objectives to acceptable levels; the organization selects and develops general control activities over technology to support the achievement of objectives; the organization deploys control activities through policies that establish what is expected and procedures that put policies into action; the organization obtains or generates and uses relevant, quality information to support the functioning of internal control; the organization internally communicates information, including objectives and responsibilities for internal control, necessary to support the functioning of internal control; the organization communicates with external parties regarding matters affecting the functioning of internal control; the organization selects, develops, and performs ongoing and/or separate evaluations to ascertain whether the components of internal control are present and functioning; and/or the organization evaluates and communicates internal control deficiencies in a timely manner to those parties responsible for taking corrective action, including senior management and the board of directors, as appropriate.

These principles may be categorized into components, including: Control Environment; Risk Assessment; Control Activities; Information and Communication; and/or Monitoring Activities.

One mapping of the principles listed above to the points-of-focus listed above is shown in Table 1.

| Principle | Associated Points-of-Focus |
|---|---|
| 1-The organization | Sets the Tone at the Top-The board of directors and management at all |
| demonstrates a | levels of the entity demonstrate through their directives, actions, and |
| commitment to | behavior the importance of integrity and ethical values to support the |
| integrity and ethical | functioning of the system of internal control. |
| values. | Establishes Standards of Conduct-The expectations of the board of |
| | directors and senior management concerning integrity and ethical values |
| | are defined in the entity's standards of conduct and understood at all |
| | levels of the organization and by outsourced service providers and |
| | business partners. |
| | Evaluates Adherence to Standards of Conduct-Processes are in place to |
| | evaluate the performance of individuals and teams against the entity's |
| | expected standards of conduct. |
| | Addresses Deviations in a Timely Manner-Deviations of the entity's |
| | expected standards of conduct are identified and remedied in a timely and |
| | consistent manner. |
| 2-The board of | Establishes Oversight Responsibilities-The board of directors identifies |
| directors | and accepts its oversight responsibilities in relation to established |
| demonstrates | requirements and expectations. |
| independence from | Applies Relevant Expertise-The board of directors defines, maintains, |
| management and | and periodically evaluates the skills and expertise needed among its |
| exercises oversight | members to enable them to ask probing questions of senior management |
| of the development | and take commensurate actions. |
| and performance of | Operates Independently-The board of directors has sufficient members |
| internal control. | who are independent from management and objective in evaluations and |
| | decision making. |
| | Provides Oversight for the System of Internal Control-The board of |
| | directors retains oversight responsibility fur management's design, |
| | implementation, and conduct of internal control: |
| | Control Environment-Establishing integrity and ethical values, |
| | oversight structures, authority and responsibility, expectations of |
| | competence, and accountability to the board. |
| | Risk Assessment-Overseeing management's assessment of risks to |
| | the achievement of objectives, including the potential impact of |
| | significant changes, fraud, and management override of internal control. |
| | Control Activities-Providing oversight to senior management in the |
| | development and performance of control activities. |
| | Information and Communication-Analyzing and discussing |
| | information relating to the entity's achievement of objectives. |
| | Monitoring Activities-Assessing and overseeing the nature and |
| | scope of monitoring activities and management's evaluation and |
| | remediation of deficiencies. |
| 3-Management | Considers All Structures of the Entity-Management and the board of |
| establishes, with | directors consider the multiple structures used (including operating units, |
| board oversight, | legal entities, geographic distribution, and outsourced service providers) |
| structures, reporting | to support the achievement of objectives. |
| lines, and | Establishes Reporting Lines-Management designs and evaluates lines |
| appropriate | of reporting for each entity structure to enable execution of authorities and |
| authorities and | responsibilities and flow of information to manage the activities of the |
| responsibilities in | entity. |
| the pursuit of | Defines, Assigns, and Limits Authorities and Responsibilities- |
| objectives. | Management and the board of directors delegate authority, define |
| | responsibilities, and use appropriate processes and technology to assign |
| | responsibility and segregate duties as necessary at the various levels of the |
| | organization: |
| | Board of Directors-Retains authority over significant decisions and |
| | reviews management's assignments and limitations of authorities and |
| | responsibilities. |
| | Senior Management-Establishes directives, guidance, and control to |
| | enable management and other personnel to understand and carry out their |
| | internal control responsibilities. |
| | Management-Guides and facilitates the execution of senior |
| | management directives at entity and its subunits. |
| | Personnel-Understands the entity's standard of conduct, assessed |
| | risks to objectives, and the related control activities at their respective |
| | levels of the entity, the expected information and communication flow, |
| | and monitoring activities relevant to their achievement of the objectives. |
| | Outsourced Service Providers-Adheres to management's definition |
| | of the scope of authority and responsibility for all non-employees |
| | engaged. |
| 4-The organization | Establishes Policies and Practices-Policies and practices reflect |
| demonstrates a | expectations of competence necessary to support the achievement of |
| commitment to | objectives. |
| attract, develop, and | Evaluates Competence and Addresses Shortcomings-The board of |
| retain competent | directors and management evaluate competence across the organization |
| individuals in | and in outsourced service providers in relation to established policies and |
| alignment with | practices, and act as necessary to address shortcomings. |
| objectives. | Attracts, Develops, and Retains Individuals-The organization provides |
| | the mentoring and training needed to attract, develop, and retain sufficient |
| | and competent personnel and outsourced service providers to support the |
| | achievement of objectives. |
| | Plans and Prepares for Succession-Senior management and the board |
| | of directors develop contingency plans for assignments of responsibility |
| | important for internal control. |
| 5-The organization | Enforces Accountability through Structures, Authorities, and |
| holds individuals | Responsibilities-Management and the board of directors establish the |
| accountable for | mechanisms to communicate and hold individuals accountable for |
| their internal | performance of internal control responsibilities across the organization |
| control | and implement corrective action as necessary. |
| responsibilities in | Establishes Performance Measures, Incentives, and Rewards- |
| the pursuit of | Management and the board of directors establish performance measures, |
| objectives. | incentives, and other rewards appropriate for responsibilities at all levels |
| | of the entity, reflecting appropriate dimensions of performance and |
| | expected standards of conduct, and considering the achievement of both |
| | short-term and longer-term objectives. |
| | Evaluates Performance Measures, incentives, and Rewards for Ongoing |
| | Relevance-Management and the board of directors align incentives and |
| | rewards with the fulfillment of internal control responsibilities in the |
| | achievement of objectives. |
| | Considers Excessive Pressures-Management and the board of directors |
| | evaluate and adjust pressures associated with the achievement of |
| | objectives as they assign responsibilities, develop performance measures, |
| | and evaluate performance. |
| | Evaluates Performance and Rewards or Disciplines Individuals- |
| | Management and the board of directors evaluate performance of internal |
| | control responsibilities, including adherence to standards of conduct and |
| | expected levels of competence and provide rewards or exercise |
| | disciplinary action as appropriate. |
| 6-The organization | External Financial Reporting Objectives |
| specifies objectives | Complies with Applicable Accounting Standards-Financial reporting |
| with sufficient | objectives are consistent with accounting principles suitable and available |
| clarity to enable the | for that entity. The accounting principles selected are appropriate in the |
| identification and | circumstances. |
| assessment of risks | Considers Materiality-Management considers materiality in financial |
| relating to | statement presentation. |
| objectives | Reflects Entity Activities-External reporting reflects the underlying |
| | transactions and events to show qualitative characteristics and assertions. |
| | External Non-Financial Reporting Objectives |
| | Complies with Externally Established Standards and Frameworks- |
| | Management establishes objectives consistent with laws and regulations, |
| | or standards and frameworks of recognized external organizations. |
| | Considers the Required Level of Precision-Management reflects the |
| | required level of precision and accuracy suitable for user needs and as |
| | based on criteria established by third parties in non-financial reporting. |
| | Reflects Entity Activities-External reporting reflects the underlying |
| | transactions and events within a range of acceptable limits. |
| 7-The organization | Includes Entity, Subsidiary, Division, Operating Unit, and Functional |
| identifies risks to | Levels-The organization identifies and assesses risks at the entity, |
| the achievement of | subsidiary, division, operating unit, and functional levels relevant to the |
| its objectives across | achievement of objectives. |
| the entity and | Analyzes Internal and External Factors-Risk identification considers |
| analyzes risks as a | both internal and external factors and their impact on the achievement of |
| basis for | objectives. |
| determining how | Involves Appropriate Levels of Management-The organization puts |
| the risks should be | into place effective risk assessment mechanisms that involve appropriate |
| managed. | levels of management. |
| | Estimates Significance of Risks Identified-identified risks are analyzed |
| | through a process that includes estimating the potential significance of the |
| | risk. |
| | Determines Flow to Respond to Risks-Risk assessment includes |
| | considering how the risk should be managed and whether to accept, avoid, |
| | reduce, or share the risk. |
| 8-The organization | Considers Various Types of Fraud-The assessment of fraud considers |
| considers the | fraudulent reporting, possible loss of assets, and corruption resulting from |
| potential for fraud | the various ways that fraud and misconduct can occur, |
| in assessing risks to | Assesses Incentive and Pressures-The assessment of fraud risk |
| the achievement of | considers incentives and pressures, |
| objectives. | Assesses Opportunities-The assessment of fraud risk considers |
| | opportunities for unauthorized acquisition, use, or disposal of assets, |
| | altering of the entity's reporting records, or committing other |
| | inappropriate acts. |
| | Assesses Attitudes and Rationalizations-The assessment of fraud risk |
| | considers how management and other personnel might engage in or justify |
| | inappropriate actions. |
| 9-The organization | Assesses Changes in the External Environment-The risk identification |
| identifies and | process considers changes to the regulatory, economic, and physical |
| assesses changes | environment in which the entity operates. |
| that could | Assesses Changes in the Business Model-The organization considers |
| significantly impact | the potential impacts of new business lines, dramatically altered |
| the system of | compositions of existing business lines, acquired or divested business |
| internal control. | operations on the system of internal control, rapid growth, changing |
| | reliance on foreign geographies, and new technologies. |
| | Assesses Changes in Leadership-The organization considers changes in |
| | management and respective attitudes and philosophies on the system of |
| | internal control. |
| 10-The organization | Integrates with Risk Assessment-Control activities help ensure that risk |
| selects and develops | responses that address and mitigate risks are carried out |
| control activities | Considers Entity-Specific Factors-Management considers how the |
| that contribute to | environment, complexity, nature, and scope of its operations, as well as |
| the mitigation of | the specific characteristics of its organization, affect the selection and |
| risks to the | development of control activities. |
| achievement of | Determines Relevant Business Processes-Management determines |
| objectives to | which relevant business processes require control activities. |
| acceptable levels. | Evaluates a Mix of Control Activity Types-Control activities include a |
| | range and variety of controls and may include a balance of approaches to |
| | mitigate risks, considering both manual and automated controls, and |
| | preventive and detective controls. |
| | Considers at What Level Activities Are Applied-Management |
| | considers control activities at various levels in the entity. |
| | Addresses Segregation of Duties-Management segregates incompatible |
| | duties, and where such segregation is not practical, selects and develops |
| | alternative control activities. |
| 11-The organization | Determines Dependency between the Use of Technology in Business |
| selects and develops | Processes and Technology General Controls-Management understands |
| general control | and determines the dependency and linkage between business processes, |
| activities over | automated control activities, and technology general controls. |
| technology to | Establishes Relevant Technology Infrastructure Control Activities- |
| support the | Management selects and develops control activities over the technology |
| achievement of | infrastructure, which are designed and implemented to help ensure the |
| objectives. | completeness, accuracy, and availability of technology processing. |
| | Establishes Relevant Security Management Process Control |
| | Activities-Management selects and develops control activities that are |
| | designed and implemented to restrict technology access rights to |
| | authorized users commensurate with their job responsibilities and to |
| | protect the entity's assets from external threats. |
| | Establishes Relevant Technology Acquisition, Development, and |
| | Maintenance Process Control Activities-Management selects and |
| | develops control activities over the acquisition, development, and |
| | maintenance of technology and its infrastructure to achieve management's |
| | objectives. |
| 12-The organization | Establishes Policies and Procedures to Support Deployment of |
| deploys control | Management's Directives-Management establishes control activities that |
| activities through | are built into business processes and employees' day-to-day activities |
| policies that | through policies establishing what is expected and relevant procedures |
| establish what is | specifying actions. |
| expected and | Establishes Responsibility and Accountability for Executing Policies and |
| procedures that put | Procedures-Management establishes responsibility and accountability |
| policies into action. | for control activities with management (or other designated personnel) of |
| | the business unit or function in which the relevant risks reside. |
| | Performs in a Timely Manner-Responsible personnel perform control |
| | activities in a timely manner as defined by the policies and procedures. |
| | Takes Corrective Action-Responsible personnel investigate and act on |
| | matters identified as a result of executing control activities. |
| | Performs Using Competent Personnel-Competent personnel with |
| | sufficient authority perform control activities with diligence and |
| | continuing focus. |
| | Reassesses Policies and Procedures-Management periodically reviews |
| | control activities to determine their continued relevance and refreshes |
| | them when necessary |
| 13-The organization | Identifies Information Requirements-A process is in place to identify |
| obtains or generates | the information required and expected to support the functioning of the |
| and uses relevant, | other components of internal control and the achievement of the entity's |
| quality information | objectives. |
| to support the | Captures Internal and External Sources of Data-Information systems |
| functioning of | capture internal and external sources of data. |
| internal control. | Processes Relevant Data into Information-Information systems process |
| | and transform relevant data into information. |
| | Maintains Quality throughout Processing-Information systems produce |
| | information that is timely, current, accurate, complete, accessible, |
| | protected, and verifiable and retained. Information is reviewed to assess |
| | its relevance in supporting the internal control components. |
| | Considers Costs and Benefits-The nature, quantity, and precision of |
| | information communicated are commensurate with and support the |
| | achievement of objectives. |
| 14-The organization | Communicates Internal Control Information-A process is in place to |
| internally | communicate required information to enable all personnel to understand |
| communicates | and carry out their internal control responsibilities. |
| information, | Communicates with the Board of Directors-Communication exists |
| including objectives | between management and the board of directors so that both have |
| and responsibilities | information needed to fulfill their roles with respect to the entity's |
| for internal control, | objectives. |
| necessary to support | Provides Separate Communication Lines-Separate communication |
| the functioning of | channels, such as whistle-blower hotlines, are in place and serve as fail- |
| internal control. | safe mechanisms to enable anonymous or confidential communication |
| | when normal channels are inoperative or ineffective. |
| | Selects Relevant Method of Communication-The method of |
| | communication considers the timing, audience, and nature of the |
| | information. |
| 15-The organization | Communicates to External Parties-Processes are in place to |
| communicates with | communicate relevant and timely information to external parties including |
| external parties | shareholders, partners, owners, regulators, customers, and financial |
| regarding matters | analysts and other external parties. |
| affecting the | Enables Inbound Communications-Open communication channels |
| functioning of | allow input from customers, consumers, suppliers, external auditors, |
| internal control. | regulators, financial analysts, and others, providing management and the |
| | board of directors with relevant information. |
| | Communicates with the Board of Directors-Relevant information |
| | resulting from assessments conducted by external parties is communicated |
| | to the board of directors. |
| | Provides Separate Communication Lines-Separate communication |
| | channels, such as whistle-blower hotlines, are in place and serve as fail- |
| | safe mechanisms to enable anonymous or confidential communication |
| | when normal channels are inoperative or ineffective. |
| | Selects Relevant Method of Communication-The method of |
| | communication considers the timing, audience, and nature of the |
| | communication and legal, regulatory, and fiduciary requirements and |
| | expectations. |
| 16-The organization | Considers a Mix of Ongoing and Separate Evaluations-Management |
| selects, develops, | includes a balance of ongoing and separate evaluations. |
| and performs | Considers Rate of Change-Management considers the rate of change in |
| ongoing and/or | business and business processes when selecting and developing ongoing |
| separate evaluations | and separate evaluations. |
| to ascertain whether | Establishes Baseline Understanding-The design and current state of an |
| the components of | internal control system are used to establish a baseline for ongoing and |
| internal control are | separate evaluations. |
| present and | Uses Knowledgeable Personnel-Evaluators performing ongoing and |
| functioning. | separate evaluations have sufficient knowledge to understand what is |
| | being evaluated. |
| | Integrates with Business Processes-Ongoing evaluations are built into |
| | the business processes and adjust to changing conditions. |
| | Adjusts Scope and Frequency-Management varies the scope and |
| | frequency of separate evaluations depending on risk. |
| | Objectively Evaluates-Separate evaluations are performed periodically |
| | to provide objective feedback. |
| 17-The organization | Assesses Results-Management and the board of directors, as |
| evaluates and | appropriate, assess results of ongoing and separate evaluations. |
| communicates | Communicates Deficiencies-Deficiencies are communicated to parties |
| internal control | responsible for taking corrective action and to senior management and the |
| deficiencies in a | board of directors, as appropriate. |
| timely manner to | Monitors Corrective Actions-Management tracks whether deficiencies |
| those parties | are remediated on a timely basis. |
| responsible for | |
| taking corrective | |
| action, including | |
| senior management | |
| and the board of | |
| directors, as | |
| appropriate. | |

According to one embodiment, calculations in the matrix 200 may be performed in a spreadsheet. For example, the rows 202A-202N may include cells having formulas to determine whether a control with a specified point-of-focus identification meets one of the principles 212-220 and 232-238. For example, a cell in the row 202A and the column 212 may include a value when the point-of-focus identification for the control in row 202A is one of points-of-focus 1-4. In another example, a cell in the row 202A and the column 214 may include a value when the point-of-focus identification for the control in row 202A is one of points-of-focus 5-8. As shown in FIG. 2, the value ‘5’ is inserted in the cell at row 202A and the column 214 because the control associated with 202A was identified with point-of-focus 5 and the principle associated with point-of-focus 5 is the principle associated with the column 214.

When new controls are added to the data input 100 or when controls are removed from the data input 100, a macro may be used to auto populate the matrix 200 for the new controls. For example, the macro may create formulas for each cell in a new row similar to the rows 202A-202N to match a point-of-focus identification for the new control to one of the principles in columns 212-220 and 232-238 and then update compliance information in rows 240 and 242.

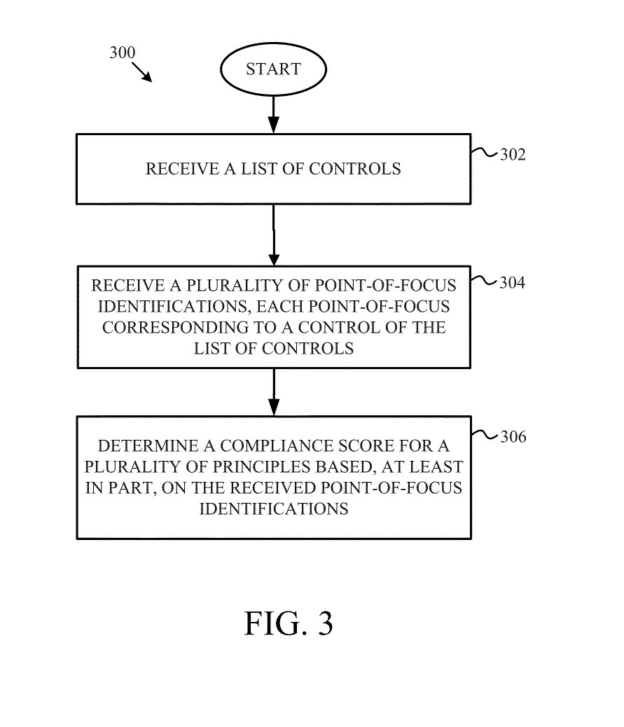

FIG. 3 is a flow chart illustrating a method of determining compliance according to one embodiment of the disclosure. A method 300 may being at block 302 with receiving a list of controls. At block 304, a plurality of point-of-focus identifications may be received, in which each point-of-focus identification corresponds to a control of the list of controls. A control may include multiple point-of-focus identifications, and a point-of-focus identification may be assigned to multiple controls. At block 306, a compliance score may be determined for a plurality of principles based, at least in part, on the received point-of-focus identifications of block 304 for the controls received at block 302.

After an initial list of controls is received, a new control may be added to the list. When a new control is inserted the method 300 may include: receiving a new control and a point of focus identification for the new control; associating the new control with a principle based, at least in part, on the point of focus identification; and/or updating the compliance score based on receiving the new control.

After an initial list of controls is received, a control may be deleted from the list. When a control is deleted the method 300 may include: receiving an indication to delete a control from the list of controls; removing the control from the list of controls; and/or updating the compliance score based, at least in part, on the updated list of controls.

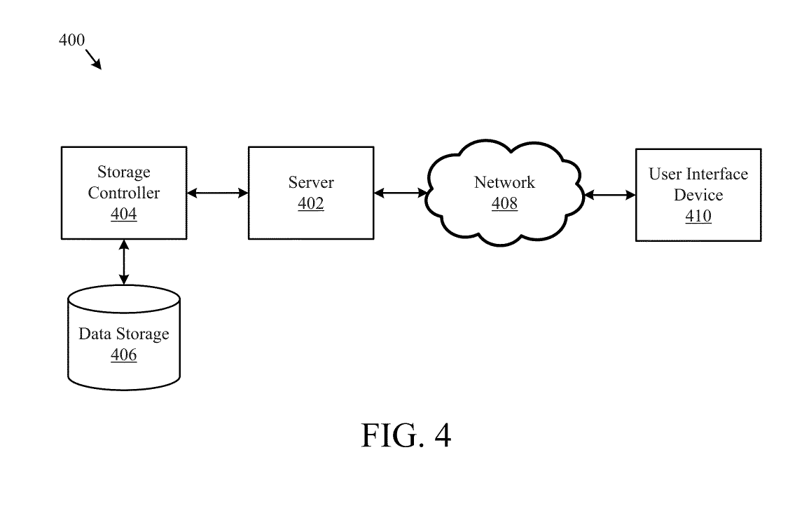

FIG. 4 illustrates one embodiment of a system 400 for an information system, including a system for determining levels of compliance. The system 400 may include a server 402, a data storage device 406, a network 408, and a user interface device 410. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone, or other mobile communication device having access to the network 408. In a further embodiment, the user interface device 410 may access the Internet or other wide area or local area network to access a web application or web service hosted by the server 402 and may provide a user interface for receiving information for determining compliance with various principles.

The network 408 may facilitate communications of data between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

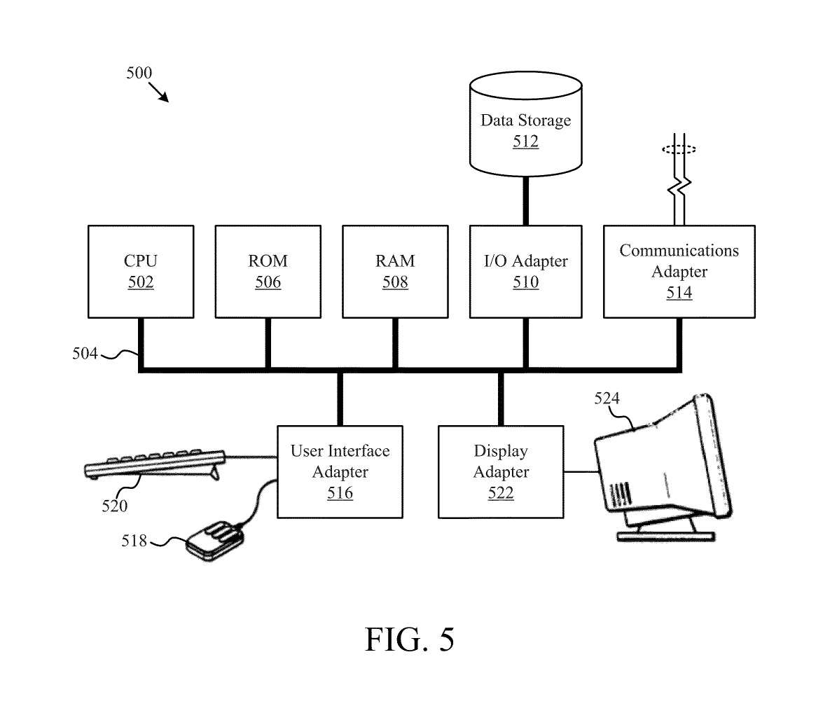

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 may also include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The user interface adapter 516 couples user input devices, such as a keyboard 520, a pointing device 518, and/or a touch screen (not shown) to the computer system 500. The keyboard 520 may be an on-screen keyboard displayed on a touch panel. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

If implemented in firmware and/or software, the functions described above, such as described with reference to FIG. 3, may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. Additionally, the firmware and/or software may be executed by processors integrated with components described above. For example, the method of FIG. 3 described above may be executed by a processor and memory integrated with and coupled to a hard disk drive (HDD) platter storage device in the data storage 406 and/or the storage controller 404 described above.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving a list of controls;
receiving a plurality of point-of-focus identifications, wherein each point-of-focus of the plurality of point-of-focus identifications correspond to a control of the list of controls; and
determining a compliance score for a plurality of principles based, at least in part, on the received point-of-focus identifications.

2. The method of claim 1, further comprising receiving the plurality of principles and a listing of points of focus associated with of each of the plurality of principles, wherein the step of determining the compliance score comprises determining a compliance for each of the plurality of principles by determining a percentage of the points of focus addressed for each of the plurality of principles.

3. The method of claim 1, wherein the compliance score indicates a level of compliance with Sarbanes-Oxley.

4. The method of claim 3, wherein the principles comprise: a commitment to integrity and ethical values; a board of directors demonstrating independence from management and exercising oversight of the development and performance of internal control; establishment of structures, reporting lines, and appropriate authorities and responsibilities in the pursuit of objectives; a commitment to attract, develop, and retain competent individuals; holding individual accountable for their internal control responsibilities; specifying objectives with sufficient clarity to enable identification and assessment of risks relating to objectives; identifying risks to the achievement of objectives across an entity; considering a potential for fraud in assessing risks; identifying and assessing changes that could impact internal controls; selecting and developing control activities that contribute to a mitigation of risks; selecting and developing general control activities over technology; deploying control activities through policies that establish expectations and procedures; obtaining relevant, quality information to support internal control; communicating information to support the functioning of internal control; communicating with external parties regarding matters affecting internal control; selecting, developing, and performing ongoing evaluations to ascertain whether internal control is functioning; and evaluating internal control deficiencies to parties responsibly for taking corrective action.

5. The method of claim 1, further comprising:
receiving a new control and a point of focus identification for the new control;
associating the new control with a principle based, at least in part, on the point of focus identification; and
updating the compliance score based on receiving the new control.

6. The method of claim 1, further comprising:
receiving an indication to delete a control from the list of controls;
removing the control from the list of controls; and
updating the compliance score based, at least in part, on the updated list of controls.

7. A computer program product, comprising:
a non-transitory computer readable medium comprising code to perform the steps of:
receiving a list of controls;
receiving a plurality of point-of-focus identifications, wherein each point-of-focus of the plurality of point-of-focus identifications correspond to a control of the list of controls; and
determining a compliance score for a plurality of principles based, at least in part, on the received point-of-focus identifications.

8. The computer program product of claim 7, in which the medium further comprises code to perform the step of receiving the plurality of principles and a listing of points of focus associated with of each of the plurality of principles, wherein the step of determining the compliance score comprises determining a compliance for each of the plurality of principles by determining a percentage of the points of focus addressed for each of the plurality of principles.

9. The computer program product of claim 7, wherein the compliance score indicates a level of compliance with Sarbanes-Oxley.

10. The computer program product of claim 9, wherein the principles comprise: a commitment to integrity and ethical values; a board of directors demonstrating independence from management and exercising oversight of the development and performance of internal control; establishment of structures, reporting lines, and appropriate authorities and responsibilities in the pursuit of objectives; a commitment to attract, develop, and retain competent individuals; holding individual accountable for their internal control responsibilities; specifying objectives with sufficient clarity to enable identification and assessment of risks relating to objectives; identifying risks to the achievement of objectives across an entity; considering a potential for fraud in assessing risks; identifying and assessing changes that could impact internal controls; selecting and developing control activities that contribute to a mitigation of risks; selecting and developing general control activities over technology; deploying control activities through policies that establish expectations and procedures; obtaining relevant, quality information to support internal control; communicating information to support the functioning of internal control; communicating with external parties regarding matters affecting internal control; selecting, developing, and performing ongoing evaluations to ascertain whether internal control is functioning; and evaluating internal control deficiencies to parties responsibly for taking corrective action.

11. The computer program product of claim 7, wherein the medium further comprises code to perform the steps of:
receiving a new control and a point of focus identification for the new control;
associating the new control with a principle based, at least in part, on the point of focus identification; and
updating the compliance score based on receiving the new control.

12. The computer program product of claim 7, wherein the medium further comprises code to perform the steps of:
receiving an indication to delete a control from the list of controls;
removing the control from the list of controls; and
updating the compliance score based, at least in part, on the updated list of controls.

13. An apparatus, comprising:
a memory; and
a processor coupled to the memory, wherein the processor is configured to perform the steps of:
receiving a list of controls;
receiving a plurality of point-of-focus identifications, wherein each point-of-focus of the plurality of point-of-focus identifications correspond to a control of the list of controls; and
determining a compliance score for a plurality of principles based, at least in part, on the received point-of-focus identifications.

14. The apparatus of claim 13, wherein the processor is further configured to perform the step of receiving the plurality of principles and a listing of points of focus associated with of each of the plurality of principles, wherein the step of determining the compliance score comprises determining a compliance for each of the plurality of principles by determining a percentage of the points of focus addressed for each of the plurality of principles.

15. The apparatus of claim 13, wherein the compliance score indicates a level of compliance with Sarbanes-Oxley.

16. The apparatus of claim 15, wherein the principles comprise: a commitment to integrity and ethical values; a board of directors demonstrating independence from management and exercising oversight of the development and performance of internal control; establishment of structures, reporting lines, and appropriate authorities and responsibilities in the pursuit of objectives; a commitment to attract, develop, and retain competent individuals; holding individual accountable for their internal control responsibilities; specifying objectives with sufficient clarity to enable identification and assessment of risks relating to objectives; identifying risks to the achievement of objectives across an entity; considering a potential for fraud in assessing risks; identifying and assessing changes that could impact internal controls; selecting and developing control activities that contribute to a mitigation of risks; selecting and developing general control activities over technology; deploying control activities through policies that establish expectations and procedures; obtaining relevant, quality information to support internal control; communicating information to support the functioning of internal control; communicating with external parties regarding matters affecting internal control; selecting, developing, and performing ongoing evaluations to ascertain whether internal control is functioning; and evaluating internal control deficiencies to parties responsibly for taking corrective action.

17. The apparatus of claim 13, wherein the processor is further configured to perform the steps of:
receiving a new control and a point of focus identification for the new control;
associating the new control with a principle based, at least in part, on the point of focus identification; and
updating the compliance score based on receiving the new control.

18. The apparatus of claim 13, wherein the processor is further configured to perform the steps of:
receiving an indication to delete a control from the list of controls;
removing the control from the list of controls; and
updating the compliance score based, at least in part, on the updated list of controls.
